(19) United States
(12) Patent Application Publication
(10) Pub. No.: US 2018/0078104 A1
(43) Pub. Date: Mar. 22, 2018

(54) VACUUM CLEANER

(71) Applicant: TTI (MACAO COMMERCIAL OFFSHORE) LIMITED, Macau (MO)

(72) Inventors: W. Steven Register, Anderson, SC (US); Daniel B. Nelson, Anderson, SC (US)

(21) Appl. No.: 15/705,350

(22) Filed: Sep. 15, 2017

Related U.S. Application Data
(60) Provisional application No. 62/396,454, filed on Sep. 19, 2016.

(51) Int. Cl. A47L 7/00; A47L 9/28; A47L 9/12; A47L 9/32; B65F 1/10; B65F 1/16

(52) U.S. Cl. CPC A47L 7/0047; A47L 9/2884; A47L 9/127; B65F 2230/116; B65F 1/105; B65F 1/16; B65F 2210/188; A47L 9/32

(57) ABSTRACT

A vacuum cleaner for placement atop a canister including a motor housing having a suction source, a handle disposed adjacent the housing for maneuvering the vacuum cleaner relative to the canister, and a lid assembly supporting the motor housing and configured to couple to the canister. The lid assembly is adjustable in size by moving between a retracted state and an expanded state to accommodate canisters of varying size.

### CROSS-REFERENCE TO RELATED APPLICATIONS

This application claims priority to co-pending U.S. Provisional Patent Application No. 62/396,454 filed Sep. 19, 2016, the entire content of which is incorporated by reference.

### FIELD OF THE INVENTION

The invention relates to vacuum cleaner, and more particularly to utility vacuum cleaners.

### SUMMARY OF THE INVENTION

In one aspect, the invention provides a vacuum cleaner for placement atop a canister including a motor housing having a suction source, a handle disposed adjacent the housing for maneuvering the vacuum cleaner relative to the canister, and a lid assembly supporting the motor housing and is configured to couple to the canister. The lid assembly is adjustable in size by moving between a retracted state and an expanded state to accommodate canisters of varying size.

In another aspect, the invention provides a vacuum cleaner configured to couple to a smaller first canister and a larger second canister, wherein the vacuum cleaner includes a motor housing having a suction source, a power source supported by the motor housing to supply power to the suction source, and a lid assembly coupled to the motor housing and configured to secure separately to both the first and second canisters. The lid assembly is adjustable in size by moving between a retracted state, in which the lid assembly is sized to couple to the first canister, and an expanded state, in which the lid assembly is sized to couple to the second canister.

### BRIEF DESCRIPTION OF THE DRAWINGS

FIG. 1 is a top perspective view of a vacuum cleaner in accordance with an embodiment of the invention.

FIG. 2 is cross sectional view of the vacuum cleaner taken along line 2-2 of FIG. 1.

FIG. 3 is a bottom perspective view of the vacuum cleaner of FIG. 1.

FIG. 4 is an exploded perspective view of the vacuum cleaner of FIG. 1, illustrating the vacuum cleaner exploded from a garbage can.

FIG. 5 is a top perspective view of a vacuum cleaner coupled to a garbage can in accordance with another embodiment of the invention.

FIG. 6 is a top perspective view of the vacuum cleaner of FIG. 5 coupled to a different garbage can.

FIG. 7 is a top perspective view of the vacuum cleaner of FIG. 5 coupled to a yet another different garbage can.

FIG. 8 is cross sectional view of the vacuum cleaner taken along line 8-8 of FIG. 5.

FIG. 9 is a bottom perspective view of the vacuum cleaner of FIG. 5.

FIG. 10 is an exploded perspective view of the vacuum cleaner of FIG. 5, illustrating the vacuum cleaner exploded from a garbage can.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

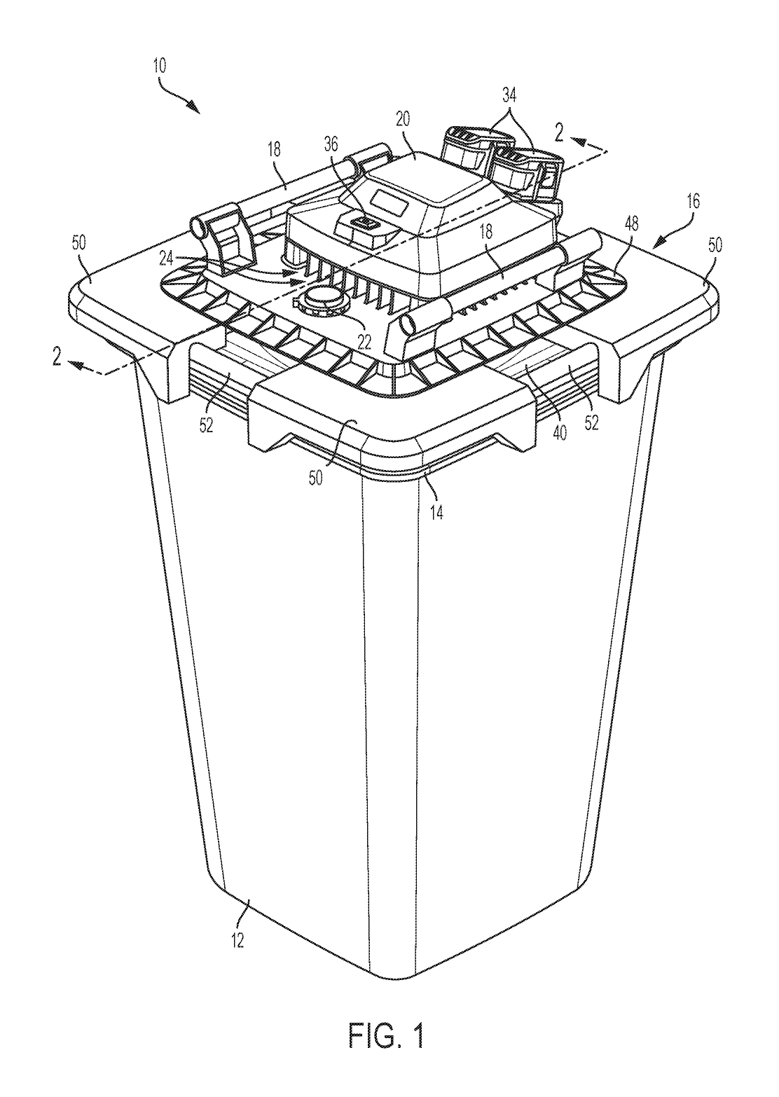

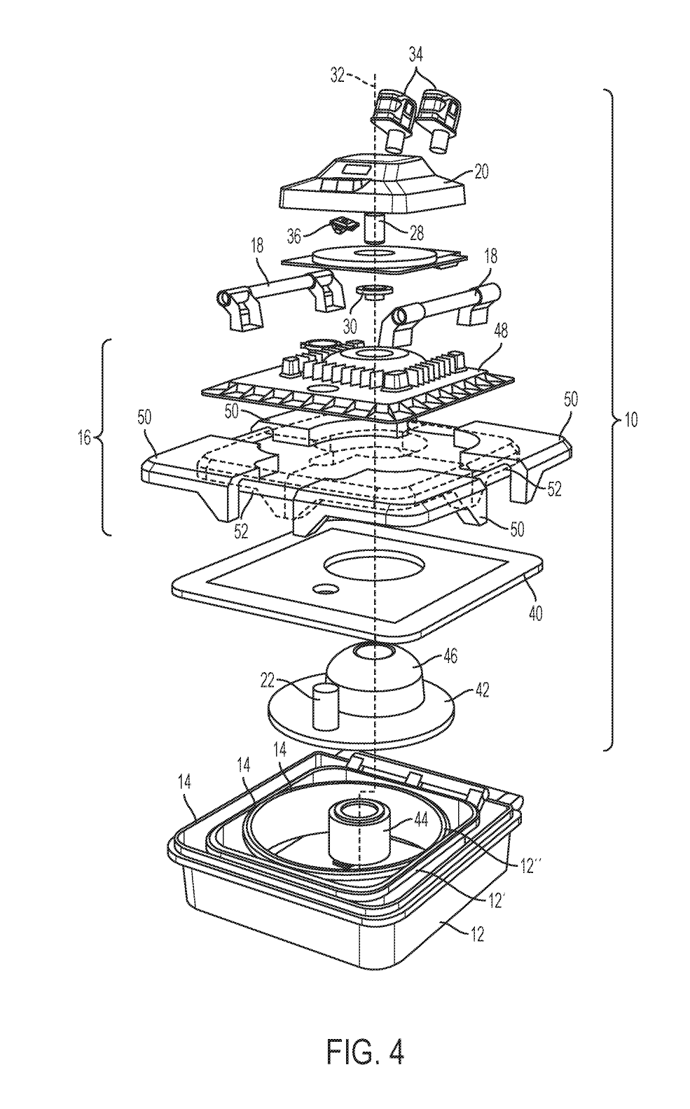

FIG. 1 illustrates a vacuum cleaner 10 configured to be mounted to a garbage can 12. The garbage can 12 collects and stores debris and includes an outer perimeter 14. The vacuum cleaner 10 is removably coupled to the garbage can 12 and includes a lid assembly 16, a pair of handles 18 to allow an operator to grasp and maneuver the vacuum cleaner 10, and a motor housing 20. The vacuum cleaner 10 is adaptable to fit on a variety of different sizes and types of containers such as garbage cans 12, 12′, and 12″ (FIG. 4).

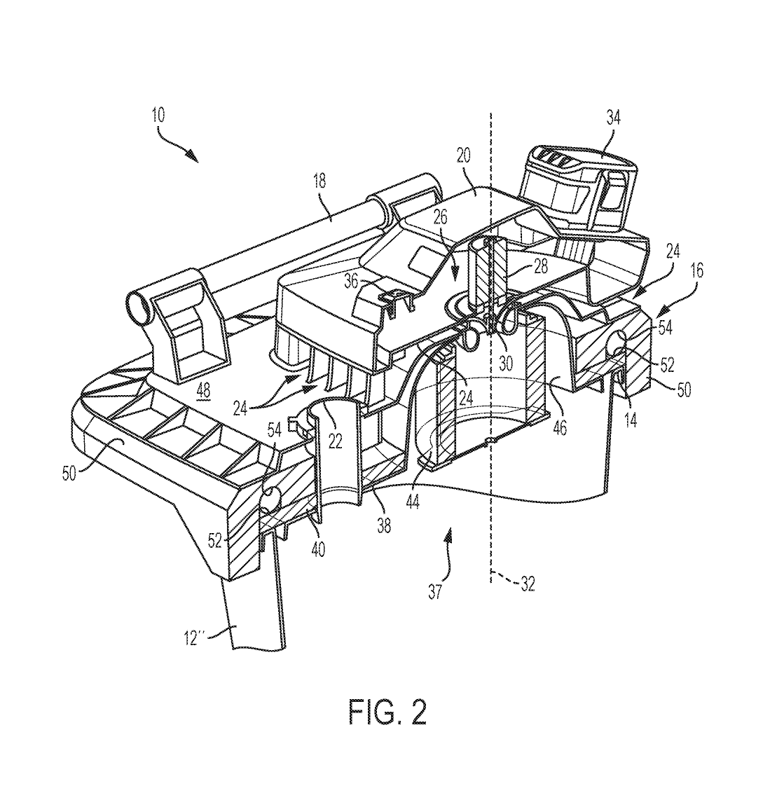

With reference to FIGS. 1 and 2, the vacuum cleaner 10 further includes an inlet port 22 that extends through the lid assembly 16 and into the garbage can 12, and an exhaust passageway 24 disposed under the motor housing 20. The inlet port 22 allows debris and air to enter the garbage can 12 while the exhaust passageway 24 discharges air from the garbage can 12. A flexible nozzle (not shown) is coupled to the inlet port 22 to extend the inlet port 22 to a cleaning surface. The vacuum cleaner 10 further includes a suction source 26 encased within the motor housing 20. The suction source 26 generates an airflow to draw air and debris into the garbage can 12. The suction source 26 includes a motor 28 and an impeller 30 (shown in FIGS. 2 and 4) rotatably driven by the motor 28. The motor 28 rotates about a drive axis 32 when the motor 28 is supplied with power via a power source, such as batteries 34. The batteries 34 selectively supply power to the motor 28 via a power switch 36. As the motor 28 is activated, the impeller 30 is also driven about the drive axis 32 which, in turn, creates a low air pressure region 37 proximate an underneath side 38 of the lid assembly 16 (or within the garbage can 12 when the lid assembly 16 is coupled to the garbage can 12). As such, air and debris is drawn into the garbage can 12 through the inlet port 22. Although not shown, the vacuum cleaner 10 further includes a bleed valve that is adjustable to control the pressure at the low air pressure region 37. In this particular embodiment, the batteries 34 are electrically connected in series in order to supply the motor 28 with power. Although the motor 28 of the illustrated embodiment draws power from the batteries 34, in other embodiments, the motor 28 could draw power from other electrical sources (e.g., wall outlet, generator, etc.).

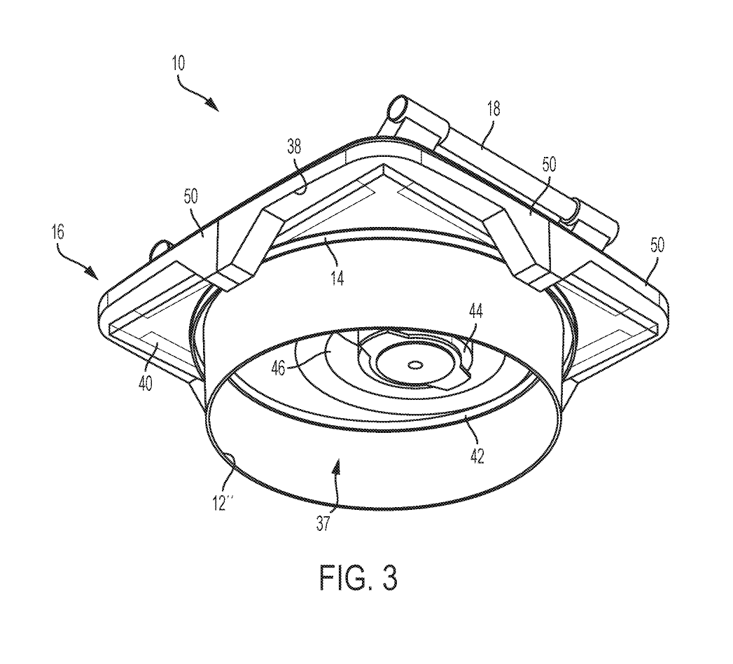

With reference to FIG. 3, the vacuum cleaner 10 further includes a gasket 40 disposed at the underneath side 38 of the lid assembly 16. The gasket 40 is composed of a foam, a rubber, or other similar types of materials. Preferably, the gasket 40 is composed of a polymer material such that the gasket 40 is flexible, and more specifically, elastic to allow the gasket 40 to deform when a force is exerted on the gasket 40. Otherwise, the gasket 40 maintains its original shape. The vacuum cleaner 10 further includes a filter retainer 42 supported by the lid assembly 16 and a filter 44 coupled to the filter retainer 42. Specifically, the filter 44 is disposed within a concavity 46 of the filter retainer 42 such that the filter 44 does not extend into the garbage can 12, as shown in FIGS. 2 and 3. In other words, the filter 44 is completely encased within the boundaries of the lid assembly 16. The filter 44 separates the debris from the air that enters the garbage can 12. In one embodiment, the filter 44 is micro-porous to enable passage of air through the filter 44 and to allow discharge of air from the vacuum 10 while inhibiting passage of debris through the filter 44. Therefore, debris is collected via the inlet port 22, is blocked from being discharged from the vacuum cleaner 10 via the filter 44, and is stored in the garbage can 12.

With reference to FIG. 4, the lid assembly 16 includes a support plate 48 and four separate lid members 50 that are moveable relative to the support plate 48. The lid members 50 are coupled together via a series of tubular members 52. Each tubular member 52 is received and moveable within a corresponding elongated groove 54 of each lid member 50. As such, each lid member 50 is slidably coupled to adjacent lid members 50. That is, the lid members 50 are capable of translating along the tubular members 52 such that the lid members 50 telescope relative to each other between a retracted state (as shown in phantom lines in FIG. 4) and an expanded state (as shown in solid lines in FIG. 4). Although there are four lid members 50 of the illustrated embodiment, in other embodiments, there may alternatively be greater or fewer than four lid members 50.

While in use, the vacuum cleaner 10 is mounted on the garbage can 12, 12′, 12″. In some cases, an operator may be required to adjust the size of the lid assembly 16 to accommodate a large container, for example, the garbage can 12. To move the lid assembly 16 from the retracted state to the expanded state (thereby increasing the size of the lid assembly 16), the operator moves the lid members 50 away from each other. Similarly, the operator may be required to adjust the size of the lid assembly 16 to accommodate a small container, for example, the garbage can 12″. To move the lid assembly 16 from the expanded state to the retracted state (thereby decreasing the size of the lid assembly 16), the operator moves each lid member 50 toward each other. Once the lid assembly 16 is correctly sized for the garbage can 12, 12′, 12″, the vacuum cleaner 10 is placed on the garbage can 12, 12′, 12″. At this point, the gasket 40 contacts the outer perimeter 14 of the garbage can 12, 12′, 12″, which ensures an airtight seal between the vacuum cleaner 10 and the garbage can 12, 12′, 12″. By depressing the power switch 36, the batteries 34 supply power to activate the motor 28 which in turn drives the impeller 30. Once the impeller 30 begins to rotate, air and debris are drawn through the inlet port 22 and into the garbage can 12, 12′, 12″. The filter 44 separates the debris from the air and the debris is stored in the garbage can 12, 12′, 12″, while the air is discharged along the exhaust passageway 24. In some situations, the pressure at the low air pressure region 37 may result in the garbage can 12, 12′, 12″ buckling or collapsing inward. In response, the operator can adjust the bleed valve to decrease the pressure in the garbage can 12, 12′, 12″. Likewise, if the pressure at the low air pressure region 37 is not sufficient to draw debris into the garbage can 12, 12′, 12″, the operator can adjust the bleed valve to increase the pressure within the garbage can 12, 12′, 12″.

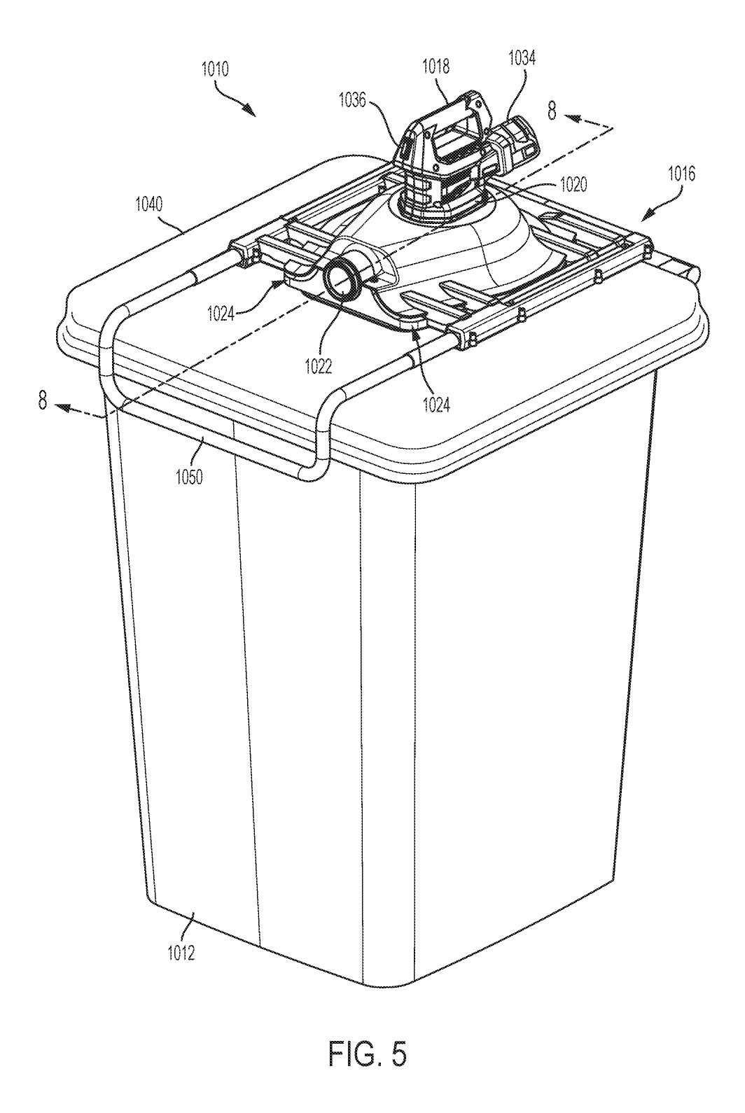

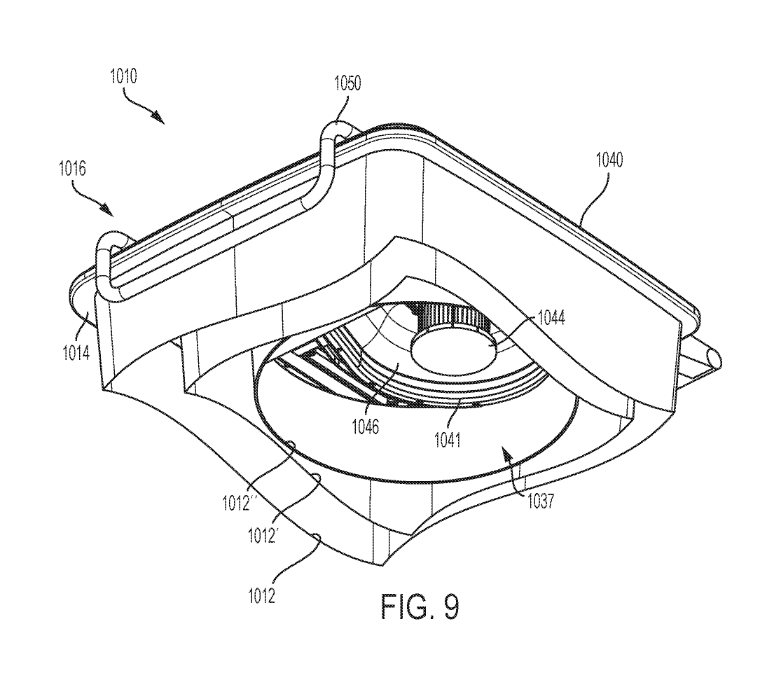

FIGS. 5-10 illustrate a vacuum cleaner 1010 in accordance with another embodiment of the invention. The vacuum cleaner 1010 is similar to the vacuum cleaner 10 described above with reference to FIGS. 1-4. Differences between the vacuum cleaners 10, 1010 are described below.

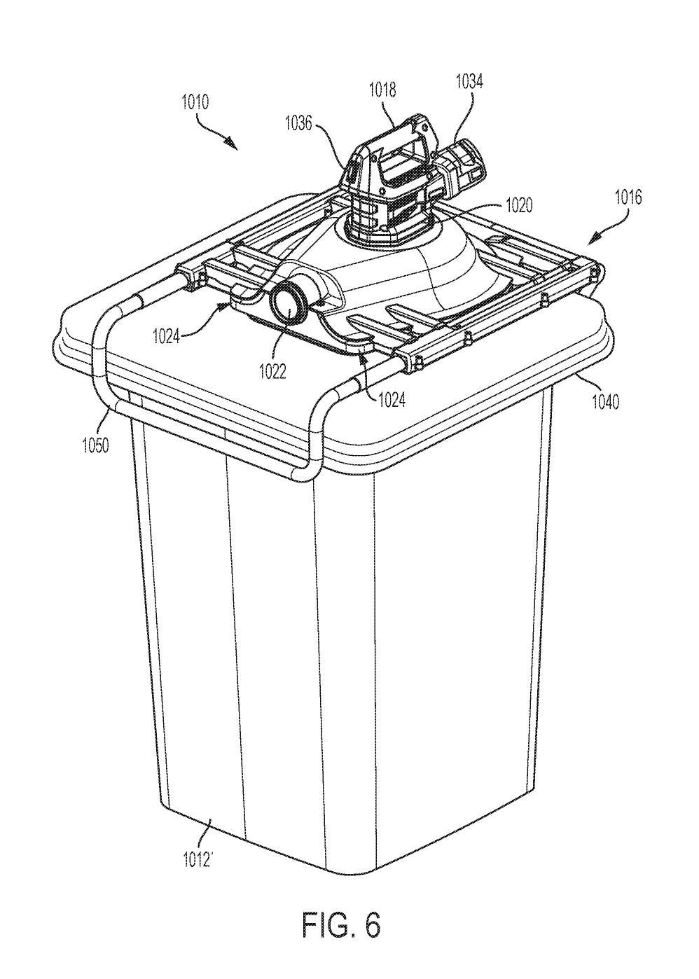

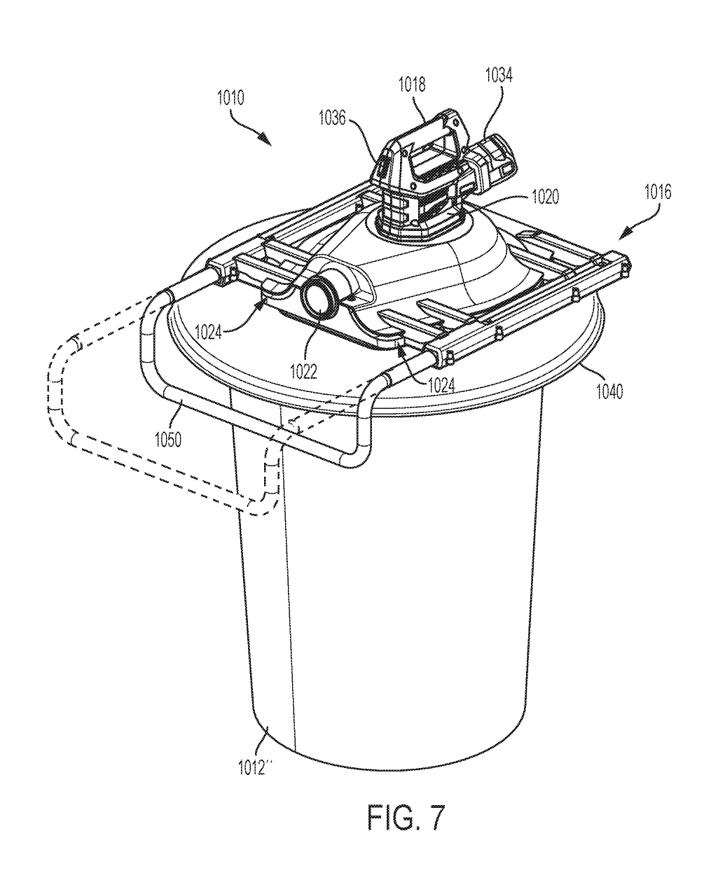

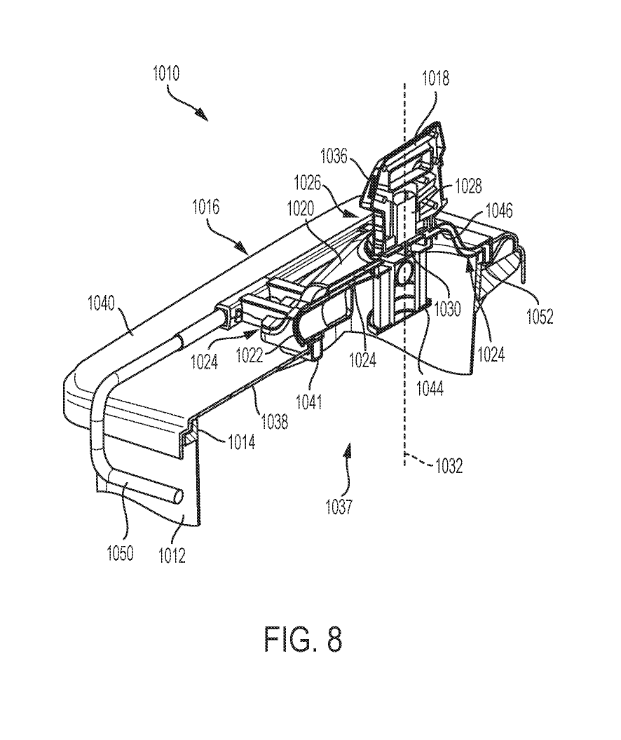

FIGS. 5-7 illustrate the vacuum cleaner 1010, which is configured to be mounted to a garbage can 1012. The garbage can 1012 collects and stores debris and includes an outer perimeter 1014 (FIG. 8). The vacuum cleaner 1010 is removably coupled to the garbage can 1012 and includes a lid assembly 1016, a handle 1018 to allow an operator to grasp and maneuver the vacuum cleaner 1010, and a motor housing 1020 supported atop the lid assembly 1016 via a motor bracket 1021. The vacuum cleaner 1010 is adaptable to fit on a variety of different sizes and types of containers such as garbage cans 1012, 1012′ (FIG. 6), and 1012″ (FIG. 7).

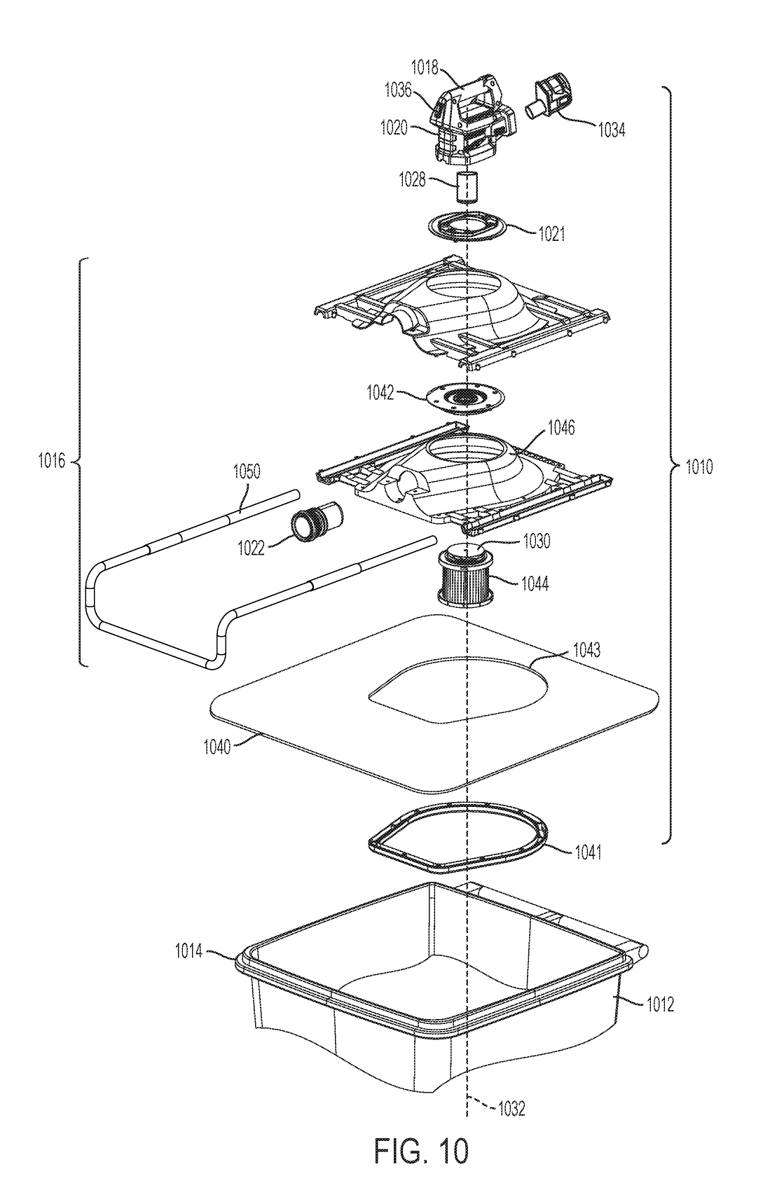

With reference to FIGS. 5-8, the vacuum cleaner 1010 further includes an inlet port 1022 that extends through the lid assembly 1016 and into the garbage can 1012 to allow debris and air to enter the garbage can 1012, and an exhaust passageway 1024 disposed under the motor housing 1020 to discharge air from the garbage can 1012. The vacuum cleaner 1010 further includes a suction source 1026 encased within the motor housing 1020. The suction source 1026 generates an airflow to draw air and debris into the garbage can 1012. The suction source 1026 includes a motor 1028 and an impeller 1030 (shown in FIGS. 8 and 10) rotatably driven by the motor 1028. The motor 1028 rotates about a drive axis 1032 when the motor 1028 is supplied with power via a power source, such as battery 1034. As the motor 1028 is activated, the impeller 1030 is also driven about the drive axis 1032 which, in turn, creates a low air pressure region 1037 proximate an underneath side 1038 of the lid assembly 1016 (or within the garbage can 1012 when the lid assembly 1016 is coupled to the garbage can 1012). As such, air and debris is drawn into the garbage can 1012 through the inlet port 1022. Although not shown, the vacuum cleaner 1010 further includes a bleed valve that is adjustable to control the pressure at the low air pressure region 1037. Although the motor 1028 of the illustrated embodiment draws power from the batteries 1034, in other embodiments, the motor 1028 could draw power from other electrical sources (e.g., wall outlet, generator, etc.).

With continued reference to FIG. 5-8, the vacuum cleaner 1010 further includes a gasket 1040 disposed between the lid assembly 1016 and a gasket retainer 1041. Specifically, the gasket retainer 1041 couples to the underneath side 1038 of the lid assembly 1016 via a plurality of fasteners (not shown) with the gasket 1040 disposed therebetween. The gasket 1040 includes an aperture 1043 for allowing fluid communication between the garbage can 1012, the inlet port 1022, and the suction source 1026. The remainder of the gasket 1040 covers the opening of the garbage can 1012 and wraps around the outer perimeter 1014 of the garbage can 1012. The gasket 1040 is composed of a polymer material such that the gasket 1040 is flexible, and more specifically, elastic to allow the gasket 1040 to deform when a force is exerted on the gasket 1040. For example, when a low air pressure region 1037 is created inside the garbage can 1012, the air pressure suctions the gasket 1040 tightly around the perimeter 1014 of the garbage can 1012 to form an airtight seal. The vacuum cleaner 1010 further includes a filter retainer 1042 supported by the lid assembly 1016 and a filter 1044 coupled to the filter retainer 1042. Specifically, the filter retainer 1042 and the filter 1044 are disposed within a concavity 1046 such that a majority of the filter 1044 does not extend beyond the concavity 1046, as shown in FIGS. 8 and 10. In other words, the filter 1044 is substantially encased within the boundaries of the lid assembly 1016. The filter 1044 separates the debris from the air that enters the garbage can 1012.

With reference to FIGS. 5-10, the lid assembly 1016 includes a lid member 1050 slidably coupled to the lid assembly 1016 between a retracted state (as shown in solid lines of FIG. 7) and an extended state (as shown in phantom lines of FIG. 7). Specifically, the lid member 1050 is capable of telescoping relative to the lid assembly 1016 between the retracted and extended states for allowing the vacuum cleaner 1010 to couple to different sized garbage cans 1012. As shown in FIG. 8, a lip 1052 of the lid assembly 1016 couples around one edge of the outer perimeter 1014 while the lid member 1050 couples around an opposing edge of the outer perimeter 1014 to secure the vacuum cleaner 1010 atop the garbage can 1012.

While in use, the vacuum cleaner 1010 is mounted on the garbage can 1012, 1012′, 1012″. In some cases, an operator may be required to adjust the size of the lid assembly 1016 to accommodate a large container, for example, the garbage can 1012. To move the lid member 1050 from the retracted state to the expanded state (thereby increasing the size of the lid assembly 1016), the operator slides the lid member 1050 away from lid assembly 1016. Similarly, the operator may be required to adjust the size of the lid assembly 1016 to accommodate a small container, for example, the garbage can 1012″. To move the lid assembly 1016 from the expanded state to the retracted state (thereby decreasing the size of the lid assembly 1016), the operator moves the lid member 1050 toward the lid assembly 1016. Once the lid assembly 1016 is correctly sized for the garbage can 1012, 1012′, 1012″, the vacuum cleaner 1010 is placed on the garbage can 1012, 1012′, 1012″. At this point, the gasket 1040 contacts the outer perimeter 1014 of the garbage can 1012, 1012′, 1012″, which ensures an airtight seal between the vacuum cleaner 1010 and the garbage can 1012, 1012′, 1012″. By depressing the power switch 1036, the battery 1034 supplies power to activate the motor 1028 which in turn drives the impeller 1030. Once the impeller 1030 begins to rotate, air and debris are drawn through the inlet port 1022 and into the garbage can 1012, 1012′, 1012″. The filter 1044 separates the debris from the air and the debris is stored in the garbage can 1012, 1012′, 1012″, while the air is discharged along the exhaust passageway 1024. In some situations, the pressure at the low air pressure region 1037 may result in the garbage can 1012, 1012′, 1012″ buckling or collapsing inward. In response, the operator can adjust the bleed valve to decrease the pressure in the garbage can 1012, 1012′, 1012″. Likewise, if the pressure at the low air pressure region 1037 is not sufficient to draw debris into the garbage can 1012, 1012′, 1012″, the operator can adjust the bleed valve to increase the pressure within the garbage can 1012, 1012′, 1012″.

Various features of the invention are set forth in the following claims.

What is claimed is:

1. A vacuum cleaner for placement atop a canister, the vacuum cleaner comprising:
a motor housing having a suction source;
a handle disposed adjacent the housing for maneuvering the vacuum cleaner relative to the canister; and
a lid assembly supporting the motor housing, the lid assembly configured to couple to the canister, the lid assembly adjustable in size by moving between a retracted state and an expanded state to accommodate canisters of varying size.

2. The vacuum cleaner of claim 1, wherein the lid assembly includes a lid member coupled to lid assembly, wherein the lid member slides relative to the lid assembly to move the lid assembly between the expanded state and the retracted state.

3. The vacuum cleaner of claim 2, wherein the lid member engages an outer perimeter of the canister to secure the lid assembly to the canister.

4. The vacuum cleaner of claim 2, wherein the lid member is a plurality of lid members that move relative to each other to engage an outer perimeter of the canister.

5. The vacuum cleaner of claim 4, wherein the lid members are coupled together via a series of tubular members, wherein the lid members are capable of translating along the tubular members such that the lid members telescope relative to each other between the retracted state and the expanded state.

6. The vacuum cleaner of claim 1, further comprising a gasket that abuts an outer perimeter of the canister to create an air tight seal between the lid assembly and the canister.

7. The vacuum cleaner of claim 6, wherein the gasket is composed of a polymer material such that the gasket is flexible to allow the gasket to deform when the lid assembly moves between the retracted state and the expanded state.

8. The vacuum cleaner of claim 1, wherein the canister is a garbage can.

9. The vacuum cleaner of claim 1, wherein the suction source includes a motor rotatable about an axis and an impeller driven by the motor.

10. The vacuum cleaner of claim 9, wherein the suction source, when activated, creates a low air pressure region within the canister.

11. The vacuum cleaner of claim 9, further comprising an exhaust passageway for discharging air from the canister in all circumferential directions relative to the axis.

12. The vacuum cleaner of claim 11, wherein the exhaust passageway is disposed underneath the motor housing.

13. The vacuum cleaner of claim 9, further comprising a battery for supplying power to the motor.

14. The vacuum cleaner of claim 1, further comprising an inlet port that extends through the lid assembly and into the canister, wherein the inlet port allows debris and air to enter the canister.

15. The vacuum cleaner of claim 1, further comprising a filter coupled to the lid assembly for separating the debris from the air that enters the canister, wherein a majority of the filter does not extend beyond the lid assembly.

16. A vacuum cleaner configured to couple to a smaller first canister and a larger second canister, the vacuum cleaner comprising:
a motor housing having a suction source;
a power source supported by the motor housing to supply power to the suction source; and
a lid assembly coupled to the motor housing and configured to secure separately to both the first and second canisters, the lid assembly adjustable in size by moving between a retracted state, in which the lid assembly is sized to couple to the first canister, and an expanded state, in which the lid assembly is sized to couple to the second canister.

17. The vacuum cleaner of claim 16, further comprising a retaining arm coupled to lid assembly and engageable with either one of the first and second canisters, wherein the retaining arm slides relative to the lid assembly to move the lid assembly between the expanded state and the retracted state.

18. The vacuum cleaner of claim 16, further comprising a gasket that abuts an outer perimeter of either one of the first and second canisters to create an air tight seal between the lid assembly and the first and second canisters.

19. The vacuum cleaner of claim 18, wherein the gasket is composed of a polymer material such that the gasket is flexible to allow the gasket to deform when the lid assembly moves between the retracted state and the expanded state.

20. The vacuum cleaner of claim 16, wherein the suction source includes a motor rotatable about an axis and an impeller driven by the motor, wherein air from either one of the first and second canisters is discharged through the lid assembly in all circumferential directions relative to the axis.
